(19) United States
(12) Patent Application Publication
(10) Pub. No.: US 2026/0150013 A1
(43) Pub. Date: May 28, 2026

(54) CELL HANDOVER METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Haitao LI, Dongguan (CN)

(21) Appl. No.: 19/454,297

(22) Filed: Jan. 20, 2026

Related U.S. Application Data
(63) Continuation of application No. PCT/CN2023/119705, filed on Sep. 19, 2023.

(51) Int. Cl. H04W 36/00; H04W 36/32

(52) U.S. Cl. CPC H04W 36/0058; H04W 36/0061; H04W 36/32

(57) ABSTRACT

Provided is a cell handover method. The method is performed by a terminal device. The method includes: transmitting first information to a network device and/or performing a handover from a serving cell to a first cell in a case where the terminal device and the first cell satisfy a first condition.

### CROSS-REFERENCE TO RELATED APPLICATION

This application is a continuation of International Application No. PCT/CN2023/119705, filed Sep. 19, 2023, the entire disclosure of which is incorporated herein by reference.

### TECHNICAL FIELD

The present disclosure relates to the field of communications, and in particular, to a cell handover method, a terminal device, and a network device.

### RELATED ART

A cell handover procedure in some practices is likely to cause a terminal device to be handed over from a source cell to a target cell too late.

### SUMMARY

The present disclosure provides a cell handover method, a terminal device, and a network device. The technical solutions are as follows.

According to some embodiments of the present disclosure, a cell handover method is provided. The method is performed by a terminal device, and includes:
transmitting first information to a network device and/or performing a handover from a serving cell to a first cell in a case where the terminal device and the first cell satisfy a first condition.

According to some embodiments of the present disclosure, a terminal device is provided. The terminal device includes:
a processor;
a receiver and/or a transmitter connected to the processor; and
a memory, configured to store one or more executable instructions of the processor;
wherein the terminal device is configured to transmit first information to a network device and/or performing a handover from a serving cell to a first cell in a case where the terminal and the first cell satisfy a first condition.

According to some embodiments of the present disclosure, a network device is provided. The network device includes:
a processor;
a receiver and/or a transmitter connected to the processor; and
a memory, configured to store one or more executable instructions of the processor;
wherein the network device is configured to configure a first condition for a terminal device, wherein the first condition is used to evaluate the terminal device and a first cell.

### BRIEF DESCRIPTION OF DRAWINGS

To describe the technical solutions according to the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 illustrates a schematic diagram of a wireless communication system according to some exemplary embodiments of the present disclosure;

FIG. 2 illustrates a schematic flowchart of a cell handover method according to some exemplary embodiments of the present disclosure;

FIG. 3 illustrates a schematic flowchart of a cell handover method according to some exemplary embodiments of the present disclosure;

FIG. 4 illustrates a schematic flowchart of a cell handover method according to some exemplary embodiments of the present disclosure;

FIG. 5 illustrates a schematic flowchart of a cell handover method according to some exemplary embodiments of the present disclosure;

FIG. 6 illustrates a schematic flowchart of a cell handover method according to some exemplary embodiments of the present disclosure;

FIG. 7 illustrates a schematic flowchart of a cell handover method according to some exemplary embodiments of the present disclosure;

FIG. 8 illustrates a schematic flowchart of a cell handover method according to some exemplary embodiments of the present disclosure;

FIG. 9 illustrates a schematic flowchart of a cell handover method according to some exemplary embodiments of the present disclosure;

FIG. 10 illustrates a schematic flowchart of a cell handover method according to some exemplary embodiments of the present disclosure;

FIG. 11 illustrates a schematic flowchart of a cell handover method according to some exemplary embodiments of the present disclosure;

FIG. 12 illustrates a schematic flowchart of a cell handover method according to some exemplary embodiments of the present disclosure;

FIG. 13 illustrates a structural block diagram of a cell handover apparatus according to some exemplary embodiments of the present disclosure;

FIG. 14 illustrates a structural block diagram of a cell handover apparatus according to some exemplary embodiments of the present disclosure; and

FIG. 15 illustrates a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. The exemplary embodiments are described in detail herein, and examples are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to limit the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” and the like may be used herein to describe various pieces of information, and such information should not be limited to these terms. These terms are only used to distinguish one type of information from another. For example, first information may also be referred to as second information, and similarly, second information is also referred to as first information, without departing from the scope of the present disclosure. The word “if,” as used herein, may be interpreted as “in a case where,” “in a case when,” or “in response to determining that,” depending on the context.

First, the communication technologies involved in the embodiments of the present disclosure are described as follows:

### Non-Terrestrial Network (NTN):

The NTN generally provides communication services to ground users through satellite communication. Compared with ground-based cellular network communication, satellite communication has many unique advantages. Firstly, satellite communication is not restricted by subscriber locations. For example, typical terrestrial communications cannot cover areas such as oceans, mountains, and deserts where communication devices cannot be installed, or regions where communication coverage is not available due to sparse population. While for satellite communication, as a satellite can cover large ground areas and orbit the earth, every corner of the earth can be covered by satellite communication theoretically. Secondly, satellite communication has a significant social value. Satellite communication can cover remote mountainous areas, poor and underdeveloped countries or regions at a lower cost, allowing people in these areas to enjoy advanced voice communication and mobile internet technology. This helps bridge the digital divide with developed areas and promotes development in these areas. Thirdly, satellite communication has a longer distance, and an increasing communication distance does not significantly increase communication costs. Lastly, satellite communication is highly stable and not restricted by natural disasters.

Communication satellites are categorized based on their orbital altitude into different types such as low-earth orbit (LEO) satellites, medium-earth orbit (MEO) satellites, geostationary earth orbit (GEO) satellites, high elliptical orbit (HEO) satellites, etc. LEO and GEO are mainly described herein.
1. LEO: The altitude of the low orbit satellite ranges from 500 km to 1500 km, with the corresponding orbital period ranging from approximately 1.5 hours to 2 hours. The signal propagation latency for single-hop communication between users is generally less than 20 ms. The maximum satellite visibility time is 20 minutes. The signal propagation distance is short, with fewer link losses, and low requirements for the transmit power at user terminal devices.
2. GEO: Geostationary earth orbit satellites have an orbital altitude of 35,786 km and a rotation period around the earth of 24 hours. The signal propagation delay for single-hop communication between subscribers is generally 250 ms.

To ensure satellite coverage and increase the system capacity of the overall satellite communication system, satellites use a plurality of beams to cover the ground, and a satellite may form dozens or even hundreds of beams to cover the ground; and a satellite beam may cover a ground area with a diameter ranging from tens to hundreds of kilometers.

### Measurement:

The measurement mainly refers to mobility measurement of a user equipment (UE) in a connected state. After a network device delivers measurement configuration to the UE, the UE detects the signal quality state of a neighbor cell based on parameters such as a measurement object and reporting configuration indicated in the measurement configuration, and feeds back measurement reporting information to the network device for the network device to perform a cell handover or optimize a neighbor cell relationship list.

### 1. Measurement Configuration

Generally, the network device transmits measurement configuration information to the UE in a connected state through radio resource control (RRC) signaling. The UE performs measurement (including one or more of intra-frequency measurement, inter-frequency measurement, and inter-technology measurement) based on the measurement configuration information, and then reports a measurement result to the network device.

The intra-frequency measurement indicates that a frequency point of a neighbor cell measured by the UE is the same as a frequency point of a serving cell of the UE. The inter-frequency measurement indicates that a frequency point of a neighbor cell measured by the UE is different from a frequency point of a serving cell of the UE.

The inter-technology measurement is also referred to as inter-system measurement, which indicates that a communication system of a neighbor cell measured by the UE is different from a communication system of a serving cell of the UE. For example, the serving cell belongs to a long-term evolution (LTE) system, and the neighbor cell belongs to a new radio (NR) system. For example, the serving cell belongs to a beyond fifth generation (B5G) mobile communication system, and the neighbor cell belongs to a 5th generation (5G) system. It should be understood that the examples herein are only intended to illustrate the meaning of the inter-technology measurement, and do not mean to limit the communication systems of the serving cell and the neighbor cell.

The network device may perform measurement configuration by using RRC connection reconfiguration, and the measurement configuration includes one or more of the following information:

### 1) Measurement Object

For intra-frequency measurement and inter-frequency measurement, each measurement object indicates a time-frequency location to be measured and a subcarrier spacing of a reference signal (RS). For a cell related to the measurement object, the network device may configure one or more of a cell offset list, a blacklist cell list, and a whitelist cell list.

For inter-technology measurement, each measurement object corresponds to a separate evolved universal terrestrial radio access (E-UTRA) frequency point. For a cell related to the E-UTRA frequency point, the network device may configure one or more of a cell offset list, a blacklist cell list, and a whitelist cell list.

In an event evaluation and measurement report process, the UE does not perform any operation on cells in the blacklist cell list. The UE performs event evaluation on cells in the whitelist cell list and reports a measurement report.

### 2) Reporting Configuration

Each measurement object corresponds to one or more reporting configurations. The reporting configuration includes one or more of: a reporting criterion, an RS type, and a reporting format.

The reporting criterion is a trigger condition for the UE to perform measurement reporting, and may be periodic trigger reporting or event trigger reporting.

The RS type is a type of RS used by the UE for beam and cell measurement, such as a synchronization signal and physical broadcast channel (PBCH) block (SS/PBCH Block, SSB) or a channel state information reference signal (CSI-RS), etc.

The reporting format includes a measurement reporting amount of the UE for each cell and each beam, and further includes other related information, such as a maximum number of cells reported by the UE and a maximum number of beams reported for each cell. The measurement reporting amount is, for example, at least one of reference signal receiving power (RSRP), received signal strength indicator (RSSI), reference signal received quality (RSRQ), signal to interference noise ratio (SINR), or the like.

Regarding the measurement event, one or more of the following measurement events are generally included:
A1 event: the signal quality of a serving cell is higher than a threshold;
A2 event: the signal quality of a serving cell is less than a threshold;
A3 event: the signal quality of a neighbor cell is higher than the signal quality of a special cell (SpCell) by a threshold, and the SpCell includes a primary cell (PCell) and a primary secondary cell (PSCell);
A4 event: the signal quality of a neighbor cell is higher than a threshold;
A5 event: the signal quality of a SpCell is less than a threshold 1 and the signal quality of a neighbor cell is higher than a threshold 2;
A6 event: the signal quality of a neighbor cell is higher than the signal quality of a secondary cell (SCell) by a threshold;
B1 event: the signal quality of an inter-technology neighbor cell is higher than a threshold, and the inter-technology neighbor cell refers to a neighbor cell whose communication system is different from the communication system of the serving cell;
B2 event: the signal quality of a PCell is less than a threshold 3, and the signal quality of an inter-technology neighbor cell is higher than a threshold 4; and
D1 event: the distance from the UE to a reference point 1 is greater than a threshold 5, and the distance from the UE to a reference point 2 is less than a threshold 6.

### 3) Measurement Identifier

A measurement identifier corresponds to a measurement object and a reporting configuration. A correspondence between the measurement object and the reporting configuration may be implicitly reflected by associating the measurement identifier with the measurement object and the reporting configuration. For example, a measurement object corresponds to a plurality of reporting configurations at the same time, and/or a reporting configuration simultaneously corresponds to a plurality of measurement objects.

### 4) Measurement Interval

The measurement interval is a period during which the UE does not need to perform signal transmission and reception with the serving cell. The measurement interval may reflect a period during which the UE performs measurement.

### 2. Measurement Reporting

The UE performs measurement based on the measurement configuration delivered by the network device, and performs evaluation of measurement reporting based on a measurement result. In the case where the reporting condition is satisfied, the UE fills in the measurement report, incorporates the measurement result into the measurement report, and transmits the measurement report to the network device.

Measurement reporting may be classified into at least the following three types:

### 1) Event Trigger

In the case where a measurement event entry condition configured by the network device is satisfied and lasts for a period of time, transmission of the measurement report is triggered, and a current measurement procedure ends after the measurement report is transmitted once. The reporting configuration of the measurement report corresponding to the event trigger includes at least one of:
a measurement event of a trigger type and a threshold parameter thereof, and the measurement event includes one or more of an A1 event, an A2 event, an A3 event, an A4 event, an A5 event, an A6 event, a B1 event, and a B2 event;
the number of reports of the measurement report, and the number takes a value of 1; or
the configured reporting interval being invalid; that is, the UE ignores the configured reporting interval regardless of the value of the reporting interval.

### 2) Periodic Reporting

After the network device performs measurement configuration, the UE measures corresponding frequency points based on information in the measurement configuration, and transmits a measurement report based on a reporting period and a reporting interval.

### 3) Event-Triggered Periodic Reporting

In the case where a measurement event entry condition configured by the network device is satisfied and lasts for a period of time, reporting of the measurement report is triggered. After the reporting is triggered, a timer between a plurality of measurements and a counter of the number of measurements are started, and the current measurement procedure ends until the number of reports reaches a requirement configured by the network device. The reporting configuration of the measurement report corresponding to the event-triggered periodic reporting includes at least one of:
a measurement event of a trigger type and a threshold parameter thereof, and the measurement event includes one or more of an A1 event, an A2 event, an A3 event, an A4 event, and an A5 event;
the number of reports of the measurement report, and the number takes a value greater than 1; or
the configured reporting interval being valid, and the reporting periodic timer being set based on the configured reporting interval parameter.

### 3. Conditional Handover (CHO)

CHO means that the UE performs the handover (on its own) in the case where one or more handover execution conditions are satisfied. The UE starts to evaluate the execution conditions after receiving the CHO configuration, and stops evaluating the execution conditions after performing the handover (including a legacy handover or CHO). CHO is performed based on CHO configuration information, and CHO is applicable to the following principles:
a candidate cell and/or a potential target cell providing CHO configuration for the UE;
a source cell providing CHO execution conditions for the UE; and
a CHO execution condition includes one or two trigger conditions.

In the case of performing the cell handover based on the measurement configuration, the terminal device needs to consider a distance between the terminal device and the source cell or the signal quality, and a distance between the terminal device and the candidate cell or the signal quality. Therefore, the terminal device performs the handover-related operation only after the preset conditions are satisfied between the terminal device and the source cell and between the terminal device and the candidate cell.

Taking a cell handover scenario related to an NTN cell as an example, in the case where the cell handover is performed based on the above measurement configuration, the terminal device may be handed over to the target cell too late, causing the terminal device to stay in an inappropriate serving cell for too long, which is not conducive to the transmission quality of the terminal device.

Exemplarily, in a cell handover scenario related to an NTN cell, the event handover is performed by using measurement reporting based on an event D1, or CHO is performed by using measurement reporting based on a conditional event D1 (condEventD1). In the event D1 and the conditional event D1, the UE needs to evaluate the distance between the UE and a serving cell (NTN cell) and the distance between the UE and a neighbor cell. The NTN cell refers to a cell in an NTN system, and the terrestrial network (TN) cell refers to a cell in a TN system.

Taking the conditional event D1 as an example, CHO is performed only in the case where the distance between the UE and the neighbor cell is less than a threshold 7 and the distance between the UE and the NTN cell is greater than a threshold 8. That is, in the case where the distance between the UE and the neighbor cell is less than the threshold 7, the execution of CHO is triggered only in the case where the UE is far enough away from a reference point of the NTN cell (that is, the distance from the UE to the NTN cell is greater than the threshold 8). In the case where the neighbor cell includes an NTN cell or a TN cell with better signal quality, the UE is actually handed over to another cell as soon as possible, instead of having to wait for the distance between the UE and the NTN cell to satisfy the conditions to perform the cell handover. Especially in a scenario in which a TN cell is within the coverage of an NTN cell, the event D1 and the conditional event D1 are more likely to cause the UE to be handed over to the TN cell too late.

Therefore, a design in which the UE is handed over from the source cell to the target cell only in the case where the distance between the UE and the source cell and the distance between the UE and the neighbor cell both satisfy the requirements is likely to cause the UE to be handed over to the target cell too late, thereby adversely affecting the transmission quality of the UE.

Based on the above problem, the present disclosure provides cell handover methods and apparatuses, a device, and a storage medium, to support the UE in performing the cell handover as soon as possible, thereby improving the transmission quality of the UE.

In the embodiments of the present disclosure, the source cell is also referred to as a serving cell. The candidate cell includes a neighbor cell, and the candidate cell is also referred to as a potential target cell.

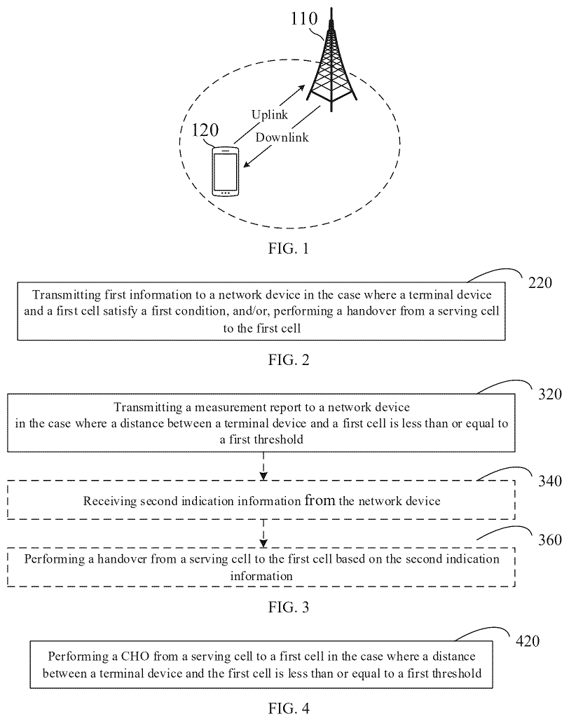

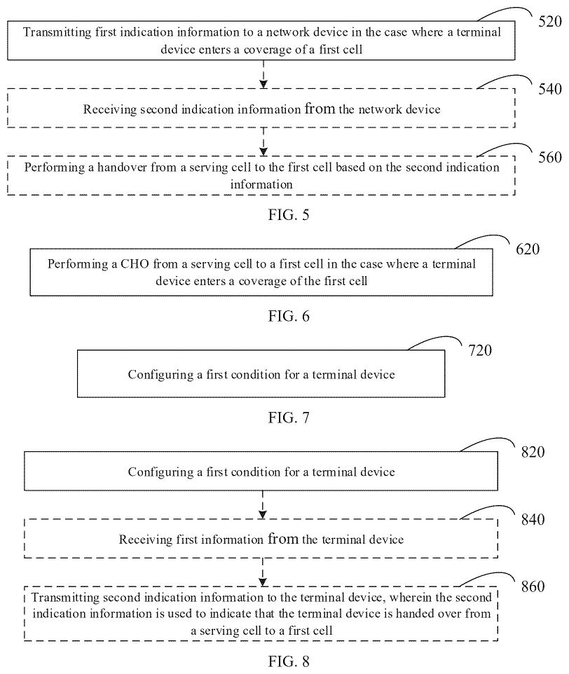

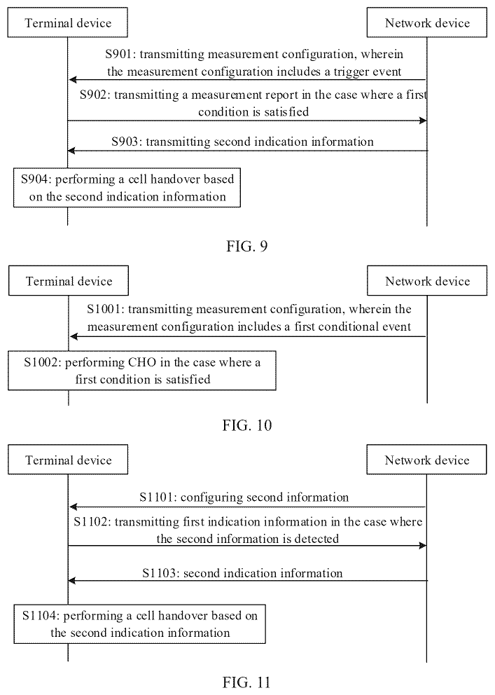

FIG. 1 illustrates a schematic diagram of a wireless communication system according to some embodiments of the present disclosure. The wireless communication system includes a network device 110 and a terminal device 120, which is not limited in the present disclosure.

The network device 110 in the present disclosure provides wireless communication functions. The network device includes but not limited to: an evolved node B (eNB), a radio network controller (RNC), a node B (NB), a base station controller (BSC), a base transceiver station (BTS), a home base station (e.g., a home evolved node B, or a home node B, HNB), a baseband unit (BBU), an access point (AP) in a wireless fidelity (Wi-Fi) system, a wireless relay node, a wireless backhaul node, a transmission point (TP) or a transmission and reception point (TRP), or the like. It may also be a next generation node B (gNB) or a transmission point (a TRP or a TP) in a 5G mobile communication system, or one or a set of antenna panels (including a plurality of antenna panels) of a base station in the 5G system, or a network node constituting a gNB or a transmission point, such as a BBU or a distributed unit (DU), or the like, or a base station in a beyond 5th generation (B5G), a 6th generation (6G) mobile communication system, or the like, or a core network (CN), a fronthaul, a backhaul, a radio access network (RAN), a network slice, or a reader/writer in a radio frequency identification (RFID).

The terminal device 120 in the present disclosure, also known as a UE, an access terminal, a user unit, a user station, a mobile station, a mobile terminal, a remote station, a remote terminal, a mobile device, a user terminal, a terminal, a wireless communication device, a user agent, a user device. The terminal includes but is not limited to: a handheld device, a wearable device, an in-vehicle device, an Internet of things device, or the like, such as: an electronic tag, a controller, a mobile phone, a tablet, an e-book reader, a laptop, a desktop computer, a television, a game console, a mobile Internet device (MID), an augmented reality (AR) terminal, a virtual reality (VR) terminal, and a mixed reality (MR) terminal, a wearable device, a handle, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set top box (STB), a customer premise equipment (CPE), or the like.

The network device 110 and the terminal device 120 communicate with each other using an air interface technology, such as a Uu interface.

In some embodiments, there are two communication scenarios between the network device 110 and the terminal device 120: an uplink communication scenario and a downlink communication scenario. The uplink communication refers to transmitting signals to the network device 110; and the downlink communication refers to transmitting signals to the terminal device 120.

The technical solutions according to the embodiments of the present disclosure may be applied to various communication systems, such as: a global system of mobile communication (GSM) system, a code division multiple access (CDMA) system, a wideband code division multiple access (WCDMA) system, a general packet radio service (GPRS) system, a long term evolution (LTE) system, a LTE frequency division duplex (FDD) system, an LTE time division duplex (TDD) system, an advanced long term evolution (LTE-A) system, a universal mobile telecommunication system (UNTS), a worldwide interoperability for microwave access (WiMAX) communication system, a 5G mobile communication system, an NR system, an evolved system of the NR system, an LTE-based access to unlicensed spectrum (LTE-U) system, an NR-based access to unlicensed spectrum (NR-U) system, a TN system, a NTN system, a wireless local area network (WLAN) system, a Wi-Fi system, a cellular Internet of things system, a cellular passive Internet of things system, and may also be applied to the subsequent evolution systems of 5G NR system, and may also be applied to B5G, 6G, and subsequent evolution systems. In some embodiments of the present disclosure, “NR” may also be referred to as 5G NR system or 5G system. Among them, the 5G mobile communication system may include non-standalone (NSA) and/or standalone (SA).

The technical solutions provided by the embodiments of the present disclosure may also be applied to a machine type communication (MTC), a long term evolution-machine (LTE-M), a device to device (D2D) network, a machine to machine (M2M) network, an Internet of things (IoT) network, or other networks. The IoT network may include an Internet of vehicles. The communication methods in the Internet of vehicles system are collectively referred to as vehicle to X (V2X, X may represent anything). For example, the V2X may include: vehicle-to-vehicle (V2V) communications, vehicle-to-infrastructure (V2I) communications, vehicle-to-pedestrian (V2P) communications, vehicle-to-network (V2N) communications, or the like.

The wireless communication system according to the embodiments is applicable to scenarios including, but not limited to, at least one of: an uplink communication scenario, a downlink communication scenario, or a sidelink communication scenario.

FIG. 2 illustrates a schematic flowchart of a cell handover method according to some exemplary embodiments of the present disclosure. The method is performed by a terminal device and includes the following processes.

In S220, in the case where the terminal device and a first cell satisfy a first condition, first information is transmitted to a network device, and/or a handover from a serving cell to the first cell is performed.

The first condition is configured by the network device or defined by a communication protocol.

In some embodiments, the first condition is related to a neighbor cell or a candidate cell of the terminal device, which should also be understood as that the first condition is used to evaluate a measurement reporting condition of the terminal device that is associated with the neighbor cell or a handover condition of the terminal device that is associated with the candidate cell. The neighbor cell or the candidate cell of the terminal device includes the first cell.

In some embodiments, the first cell is also referred to as a target cell, and the serving cell is also referred to as a source cell.

In some embodiments, the first condition includes at least one of: a distance between the terminal device and the first cell being less than a first threshold; the distance between the terminal device and the first cell being equal to the first threshold; or the terminal device entering the coverage of the first cell.

In some embodiments, the first condition includes a case where a distance between the terminal device and the first cell is less than a first threshold, and/or the terminal device enters the coverage of the first cell.

In some embodiments, the first condition includes a case where a distance between the terminal device and the first cell is equal to a first threshold, and/or the terminal device enters the coverage of the first cell.

In some embodiments, the network device includes a network device corresponding to a serving cell of the terminal device. In some embodiments, the network device includes one or more of a satellite, an access network device, and an NTN gateway.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like.

In some embodiments, the first condition includes a case where a distance between the terminal device and the first cell is less than or equal to a first threshold, and S220 is implemented as S320. In some embodiments, the cell handover method further includes S340 and/or S360, as shown in FIG. 3. FIG. 3 illustrates a schematic flowchart of a cell handover method according to some exemplary embodiments of the present disclosure. The method is performed by a terminal device, and includes at least part of the following processes.

In S320, a measurement report is transmitted to the network device in the case where the distance between the terminal device and the first cell is less than or equal to the first threshold.

In the process, the measurement report is used to indicate that the distance between the terminal device and the first cell is less than or equal to the first threshold. The first information includes the measurement report.

In some embodiments, the measurement report further includes a measurement result of the serving cell and/or a measurement result of the first cell.

In some embodiments, the first threshold is configured by the network device, or defined by the communication protocol, or determined by the terminal device based on the configuration of the network device, or determined by the terminal device based on the communication protocol.

In some embodiments, before S320, the terminal device receives the measurement configuration from the network device. The measurement configuration includes at least one of the measurement object, the reporting configuration, the measurement identifier, or the measurement interval as described above.

In some embodiments, the terminal device evaluates, based on the measurement configuration from the network device, whether the terminal device and the first cell satisfy the first condition.

In some embodiments, the terminal device transmits the measurement report to the network device in the case where the first condition is continuously satisfied. That is, in the case where the distance between the terminal device and the first cell remains less than or equal to the first threshold within a first time period, the terminal device transmits the measurement report to the network device. In some embodiments, the first time period is determined based on the measurement configuration.

In some embodiments, in the case where the distance between the terminal device and the first cell is less than or equal to the first threshold, the terminal device adds a first measurement report entry to a measurement report list variable.

In some embodiments, the first measurement report entry is associated with a case where the distance between the terminal device and the first cell is less than or equal to the first threshold.

In some embodiments, the first measurement report entry is associated with a measurement report indicating that the distance between the terminal device and the first cell is less than or equal to the first threshold.

In S340, second indication information from the network device is received.

The second indication information is used to indicate that the terminal device is handed over from the serving cell to the first cell.

In some embodiments, the second indication information is determined by the network device at least based on a measurement report from the terminal device.

In S360, the handover is performed from the serving cell to the first cell based on the second indication information.

In some embodiments, the first condition belongs to a trigger event, and the trigger event is used to trigger the terminal device to transmit the measurement report to the network device. It should also be understood that the terminal device transmits the measurement report to the network device based on an event of an event trigger type.

In some embodiments, the handover from the serving cell to the first cell is an event-triggered cell handover.

In some embodiments, the terminal device performs the first process in the case where the terminal device and the first cell satisfy a second condition. In some embodiments, the second condition belongs to a trigger event.

In some embodiments, the first process includes at least one of:
deleting the first measurement report entry from the measurement report list variable;
refraining from transmitting first information to a network device;
refraining from performing a handover from a serving cell to a first cell;
transmitting second information to the network device, and the second information is used to indicate that the terminal device satisfies a second condition; or
transmitting the second information to the network device, and the second information is used to indicate that the terminal device does not satisfy a first condition.

In some embodiments, in the case where the terminal device and the first cell satisfy the second condition, the terminal device considers that the terminal device and the first cell do not satisfy the first condition, and deletes the first measurement report entry from the measurement report list.

In some embodiments, the network device further transmits leave reporting configuration (e.g., reportOnLeave) to the terminal device. In the case where the leave reporting configuration takes a value of a first value (e.g., the value of “1,” “0,” or “True”), the terminal device transmits the second information in the case where the terminal device and the first cell satisfy the second condition. The second information is used to indicate that the terminal device satisfies the second condition and/or the terminal device does not satisfy the first condition.

In some embodiments, the second condition includes a case where a distance between the terminal device and the first cell is greater than or equal to a second threshold. In some embodiments, the second threshold is configured by the network device, or defined by the communication protocol, or determined by the terminal device based on the configuration of the network device, or determined by the terminal device based on the communication protocol.

In some embodiments, the terminal device performs the first process in the case where the second condition is continuously satisfied. That is, in the case where the distance between the terminal device and the first cell is greater than or equal to the second threshold within the second time period, the terminal device performs the first process. In some embodiments, the second time period is determined based on the measurement configuration. In some embodiments, the second time period is the same as or different from the first time period.

In some embodiments, both the first condition and the second condition belong to trigger events. In some embodiments, the first condition is an entry condition for the trigger event, and the second condition is an exit condition for the trigger event.

In some embodiments, the trigger event is configured by the network device or defined by the communication protocol.

In some embodiments, the configuration information of the trigger event includes at least one of:
a reference location;
a first parameter value; or
a third threshold.

In some embodiments, the first threshold is the third threshold, or the first threshold is a difference between the third threshold and the first parameter value.

In some embodiments, the second threshold is the third threshold, or the second threshold is a sum of the third threshold and the first parameter value.

In some embodiments, the distance between the terminal device and the first cell is represented by a distance between the terminal device and a reference location. In some embodiments, the reference location is at the center of the first cell, or the reference location is a location of the network device corresponding to the first cell.

In some embodiments, the reference location is indicated by referenceLocation in the reporting configuration.

In some embodiments, the first parameter value is indicated by hysteresisLocation in the reporting configuration.

In some embodiments, the third threshold is indicated by distanceThreshFromReference in the reporting configuration.

Exemplarily, the reporting configuration is reportConfigNR. In some embodiments, the serving cell and the first cell have a same frequency, or the serving cell and the first cell have different frequencies.

In some embodiments, the serving cell and the first cell belong to the same communication system, or the serving cell and the first cell belong to different communication systems.

In some embodiments, the serving cell belongs to a TN system; that is, the serving cell is a TN cell. The first cell belongs to an NTN system or a TN system; that is, the first cell is an NTN cell or a TN cell.

In some embodiments, the serving cell belongs to an NTN system; that is, the serving cell is an NTN cell. The first cell belongs to an NTN system or a TN system; that is, the first cell is an NTN cell or a TN cell.

In a scenario in which the serving cell is an NTN cell and the first cell is a TN cell, compared with the NTN cell, the TN cell has obvious advantages in terms of the transmission bandwidth, the cell capacity, the transmission delay, and the like, such that an improvement of the terminal device in the transmission quality due to acquisition of the TN cell as soon as possible is very beneficial to a communication service of the terminal device.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the first condition belongs to a trigger event, and the handover from the serving cell to the first cell is considered as an event-triggered cell handover. In the case where the UE is close enough to the first cell, reporting of the measurement report is triggered, such that the network device delivers a cell handover indication in time, and thus the UE is handed over from the serving cell to the first cell as soon as possible. Therefore, in the method according to the embodiments of the present disclosure, it is ensured that the terminal device is handed over to the first cell as soon as possible, and accuracy and rationality of the cell handover are ensured by reporting the measurement report.

In addition, a design in which the terminal device does not trigger the cell handover in the case where the second condition is satisfied is further provided, to avoid a case where the terminal device is mistakenly handed over to an inappropriate candidate cell. The cell handover condition of the terminal device is limited to ensure the transmission quality of the terminal device.

In some embodiments, the first condition includes a case where the distance between the terminal device and the first cell is less than or equal to the first threshold, and S220 is implemented as S420, as shown in FIG. 4. FIG. 4 illustrates a schematic flowchart of a cell handover method according to some exemplary embodiments of the present disclosure. The method is performed by a terminal device, and includes at least part of the following processes.

In S420, CHO from a serving cell to a first cell is performed in the case where a distance between the terminal device and the first cell is less than or equal to a first threshold.

In some embodiments, the first threshold is configured by the network device, or defined by the communication protocol, or determined by the terminal device based on the configuration of the network device, or determined by the terminal device based on the communication protocol.

In some embodiments, the terminal device performs the CHO from the serving cell to the first cell in the case where a first condition is continuously satisfied. That is, in the case where the distance between the terminal device and the first cell remains less than or equal to the first threshold within a first time period, the terminal device performs the CHO from the serving cell to the first cell. In some embodiments, the first time period is determined based on the measurement configuration.

In some embodiments, the CHO from the serving cell to the first cell is performed in the case where the distance between the terminal device and the first cell is less than or equal to the first threshold and a second conditional event is satisfied.

The second conditional event includes a CHO execution condition corresponding to the first cell, other than a first conditional event. In some embodiments, the second conditional event is configured by the network device or defined by the communication protocol.

In some embodiments, in the case where the first condition is continuously satisfied and the second conditional event is satisfied, the terminal device performs the CHO from the serving cell to the first cell. That is, in the case where the distance between the terminal device and the first cell remains less than or equal to the first threshold within the first time period, and the second conditional event is satisfied, the terminal device performs the CHO from the serving cell to the first cell. In some embodiments, the first time period is determined based on the measurement configuration.

In some embodiments, the first condition belongs to the first conditional event; that is, the first condition belongs to the CHO execution condition, and the handover from the serving cell to the first cell is the CHO.

It should be noted that, in the embodiments of the present disclosure, the conditional event includes an event used to evaluate the CHO execution condition. Alternatively, the conditional event includes an event used to evaluate whether to execute CHO.

In some embodiments, in the case where the terminal device and the first cell satisfy the second condition, the CHO from the serving cell to the first cell is not performed. In some embodiments, the second condition belongs to the first conditional event.

In some embodiments, the second condition includes a case where a distance between the terminal device and the first cell is greater than or equal to a second threshold. In some embodiments, the second threshold is configured by the network device, or defined by the communication protocol, or determined by the terminal device based on the configuration of the network device, or determined by the terminal device based on the communication protocol.

In some embodiments, in the case where the second condition is continuously satisfied, the terminal device does not perform the CHO from the serving cell to the first cell. That is, in the case where the distance between the terminal device and the first cell is greater than or equal to a second threshold within the second time period, the terminal device does not perform the CHO from the serving cell to the first cell. In some embodiments, the second time period is determined based on the measurement configuration. In some embodiments, the second time period is the same as or different from the first time period.

In some embodiments, both the first condition and the second condition belong to the first conditional event. In some embodiments, the first condition is an entry condition for the first conditional event, and the second condition is an exit condition for the first conditional event.

In some embodiments, the first conditional event is configured by the network device or defined by the communication protocol.

In some embodiments, the configuration information of the first conditional event includes at least one of:
a reference location;
a first parameter value; or
a third threshold.

In some embodiments, the first threshold is the third threshold, or the first threshold is a difference between the third threshold and the first parameter value.

In some embodiments, the second threshold is the third threshold, or the second threshold is a sum of the third threshold and the first parameter value.

In some embodiments, the distance between the terminal device and the first cell is represented by a distance between the terminal device and a reference location. In some embodiments, the reference location is at the center of the first cell, or the reference location is a location of the network device corresponding to the first cell.

In some embodiments, before S420, the terminal device receives the CHO configuration and/or the CHO execution condition from the network device. The first condition belongs to the CHO execution condition. In some embodiments, the network device transmitting the CHO configuration is a serving cell and/or a candidate cell and/or a neighbor cell of the terminal device. In some embodiments, the network device transmitting the CHO execution condition is a serving cell and/or a candidate cell and/or a neighbor cell of the terminal device.

In some embodiments, after receiving the CHO configuration, the terminal device starts to evaluate the CHO execution condition, that is, starts to evaluate whether the terminal device and the first cell satisfy the first condition.

In some embodiments, after receiving the CHO configuration, the terminal device starts to evaluate the CHO execution condition, that is, starts to evaluate whether the terminal device and the first cell satisfy the first condition and evaluate whether the second conditional event is satisfied.

In some embodiments, the serving cell and the first cell have a same frequency, or the serving cell and the first cell have different frequencies.

In some embodiments, the serving cell and the first cell belong to the same communication system, or the serving cell and the first cell belong to different communication systems.

In some embodiments, the serving cell belongs to a TN system; that is, the serving cell is a TN cell. The first cell belongs to an NTN system or a TN system; that is, the first cell is an NTN cell or a TN cell.

In some embodiments, the serving cell belongs to an NTN system; that is, the serving cell is an NTN cell. The first cell belongs to an NTN system or a TN system; that is, the first cell is an NTN cell or a TN cell.

In a scenario in which the serving cell is an NTN cell and the first cell is a TN cell, compared with the NTN cell, the TN cell has obvious advantages in terms of the transmission bandwidth, the cell capacity, the transmission delay, and the like, such that an improvement of the terminal device in the transmission quality due to acquisition of the TN cell as soon as possible is very beneficial to a communication service of the terminal device.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the first condition belongs to the first conditional event, and the handover from the serving cell to the first cell is considered as a CHO-type cell handover. In the case where the UE is close enough to the first cell, the CHO from the serving cell to the first cell is performed. Therefore, in the method according to the embodiments of the present disclosure, it is ensured that the terminal device is handed over to the first cell as soon as possible, simplicity of the cell handover is further improved, and consumption of transmission resources required for the indication information and the measurement report is reduced. The introduction of the second conditional event further ensures the accuracy and rationality of the cell handover on the basis of the first conditional event.

In addition, a design in which the terminal device does not trigger the cell handover in the case where the second condition is satisfied is further provided, to avoid a case where the terminal device is mistakenly handed over to an inappropriate candidate cell. The cell handover condition of the terminal device is limited to ensure the transmission quality of the terminal device.

In some embodiments, the first condition includes a case where the terminal device enters the coverage of the first cell, and S220 is implemented as S520. In some embodiments, the cell handover method further includes S540 and/or S560, as shown in FIG. 5. FIG. 5 illustrates a schematic flowchart of a cell handover method according to some exemplary embodiments of the present disclosure. The method is performed by a terminal device, and includes at least part of the following processes.

In S520, first indication information is transmitted to a network device in the case where the terminal device enters the coverage of a first cell.

The first indication information is used to indicate that the terminal device enters the coverage of the first cell. The first information includes the first indication information.

In some embodiments, the first indication information is transmitted by using RRC signaling or media access control (MAC) signaling.

In some embodiments, the first indication information includes a measurement report, or the first indication information includes a proximity indication.

In some embodiments, the terminal device entering the coverage of the first cell is determined based on the second information; that is, whether the first condition is satisfied is evaluated by the terminal device based on the second information from the network device.

In some embodiments, the second information is configured by the network device or defined by a communication protocol.

In some embodiments, the second information includes at least one of:
a measurement result of at least one candidate cell, and the measurement result of the at least one candidate cell is associated with the coverage of the first cell;
a measurement result of at least one beam, wherein the measurement result of the at least one beam is associated with the coverage of the first cell;
non-cellular wireless information; or
location information of a TN cell.

The measurement result of the at least one candidate cell being associated with the coverage of the first cell should also be understood as that whether the terminal device enters the coverage of the first cell may be determined based on the measurement result of the at least one candidate cell. The measurement result of the at least one beam being associated with the coverage of the first cell should also be understood as that whether the terminal device enters the coverage of the first cell may be determined based on the measurement result of the at least one beam.

In the present disclosure, the measurement result may be represented by at least one of: an RSRP value, an RSSI value, an RSRQ value, an SINR value, a cross link interference (CLI) value, a channel state information (CSI) value, or the like.

The non-cellular wireless information refers to information carried or indicated by a non-cellular wireless signal. The non-cellular wireless signal includes at least one of: a WLAN signal, a Wi-Fi signal, a Bluetooth signal, or a radar signal.

In some embodiments, the non-cellular wireless information includes at least one of: information carried by a WLAN signal; information indicated by a WLAN signal; information carried by a Wi-Fi signal; information indicated by a Wi-Fi signal; information carried by a Bluetooth signal; information indicated by a Bluetooth signal; information carried by a radar signal; or information indicated by a radar signal.

In some embodiments, in the case of receiving or detecting the non-cellular wireless information, the terminal device determines that the terminal device has entered the coverage of the first cell. Alternatively, the terminal device determines, based on a detection result of the non-cellular wireless information, that the terminal device has entered the coverage of the first cell.

The location information of the first cell is used to indicate the coverage of the first cell, an absolute geographical location of the network device in the first cell, and a relative geographical location of the network device in the first cell. In some embodiments, the location information of the first cell describes the coverage of the first cell by using a circle, a square, a hexagon, or a polygon, and describes the center of the first cell by using the longitude, the latitude, or coordinates. In some embodiments, the location information of the first cell describes the coverage of the first cell by using a circle, a square, a hexagon, or a polygon, and describes the location of the network device corresponding to the first cell by using the longitude, the latitude, or coordinates.

In some embodiments, the terminal device determines, based on the location information of the first cell, whether the terminal device has entered the coverage of the first cell. In some embodiments, the terminal device determines, based on the location information of the first cell and the location information of the terminal device, whether the terminal device has entered the coverage of the first cell.

In some embodiments, before S520, the terminal device receives the second information from the network device. In some embodiments, the second information is transmitted through RRC dedicated signaling. In some embodiments, the network device transmitting the second information is a serving cell, a candidate cell, or a neighbor cell of the terminal device.

In some embodiments, in the case where the first condition is continuously satisfied, the terminal device transmits the first indication information to the network device. That is, in the case where the terminal device remains within the coverage of the first cell within the first time period, or the terminal device is within the coverage of the first cell within the first time period all the time, the terminal device transmits the first indication information to the network device. In some embodiments, the first time period is determined based on the measurement configuration.

In S540, second indication information from the network device is received.

The second indication information is used to indicate that the terminal device is handed over from the serving cell to the first cell.

In some embodiments, the second indication information is determined by the network device at least based on the first indication information.

In S560, the handover is performed from the serving cell to the first cell based on the second indication information.

In some embodiments, the first condition belongs to a trigger event, and the trigger event is used to trigger the terminal device to transmit the second indication information to the network device. It should also be understood that the terminal device transmits the second indication information to the network device based on an event-triggered event.

In some embodiments, the handover from the serving cell to the first cell is an event-triggered cell handover.

In some embodiments, the terminal device performs the second process in the case where the terminal device and the first cell satisfy a second condition. In some embodiments, the second condition belongs to a trigger event.

In some embodiments, the second process includes at least one of:
refraining from transmitting first information to a network device;
refraining from performing a handover from a serving cell to a first cell;
transmitting second information to the network device, and the second information is used to indicate that the terminal device satisfies a second condition; or
transmitting the second information to the network device, and the second information is used to indicate that the terminal device does not satisfy a first condition.

In some embodiments, the second condition includes a case where the terminal device does not enter the coverage of the first cell, or includes a case where the terminal device does not remain within the coverage of the first cell within the second time period.

In some embodiments, the case where the terminal device does not enter the coverage of the first cell is determined based on the second information; that is, whether the first condition is satisfied is evaluated by the terminal device based on the second information from the network device.

In some embodiments, both the first condition and the second condition belong to trigger events. In some embodiments, the first condition is an entry condition for the trigger event, and the second condition is an exit condition for the trigger event.

In some embodiments, the serving cell and the first cell have a same frequency, or the serving cell and the first cell have different frequencies.

In some embodiments, the serving cell and the first cell belong to the same communication system, or the serving cell and the first cell belong to different communication systems.

In some embodiments, the serving cell belongs to a TN system; that is, the serving cell is a TN cell. The first cell belongs to an NTN system or a TN system; that is, the first cell is an NTN cell or a TN cell.

In some embodiments, the serving cell belongs to an NTN system; that is, the serving cell is an NTN cell. The first cell belongs to an NTN system or a TN system; that is, the first cell is an NTN cell or a TN cell.

In a scenario in which the serving cell is an NTN cell and the first cell is a TN cell, compared with the NTN cell, the TN cell has obvious advantages in terms of the transmission bandwidth, the cell capacity, the transmission delay, and the like, such that an improvement of the terminal device in the transmission quality due to acquisition of the TN cell as soon as possible is very beneficial to a communication service of the terminal device.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the first condition belongs to a trigger event, and the handover from the serving cell to the first cell is considered as an event-triggered cell handover. In the case where the UE determines, based on the first information, that the UE enters the coverage of the first cell, reporting of the first indication information is triggered, such that the network device delivers a cell handover indication in time, and thus the UE is handed over from the serving cell to the first cell as soon as possible. Therefore, in the method according to the embodiments of the present disclosure, it is ensured that the terminal device is handed over to the first cell as soon as possible, and accuracy and rationality of the cell handover are ensured by reporting the first indication information.

In some embodiments, the first condition includes a case where the terminal device enters the coverage of the first cell, and S220 is implemented as S620, as shown in FIG. 6. FIG. 6 illustrates a schematic flowchart of a cell handover method according to some exemplary embodiments of the present disclosure. The method is performed by a terminal device, and includes at least part of the following processes.

In S620, CHO from a serving cell to a first cell is performed in the case where the terminal device enters the coverage of the first cell.

In some embodiments, the terminal device entering the coverage of the first cell is determined based on the second information; that is, whether the first condition is satisfied is evaluated by the terminal device based on the second information from the network device.

For related content of the second information, reference may be made to S520. Details are not described herein again.

In some embodiments, before S620, the terminal device receives the second information from the network device. In some embodiments, the second information is transmitted through RRC dedicated signaling. In some embodiments, the network device transmitting the second information is a serving cell or a candidate cell of the terminal device.

In some embodiments, the first condition belongs to a CHO execution condition, and the handover from the serving cell to the first cell is the CHO.

In some embodiments, in the case where the terminal device and the first cell satisfy the second condition, the CHO from the serving cell to the first cell is not performed. In some embodiments, the second condition belongs to the first conditional event.

In some embodiments, the second condition includes a case where the terminal device does not enter the coverage of the first cell.

In some embodiments, both the first condition and the second condition belong to the first conditional event. In some embodiments, the first condition is an entry condition for the first conditional event, and the second condition is an exit condition for the first conditional event.

In some embodiments, the first conditional event is configured by the network device or defined by the communication protocol.

It should be noted that, in the embodiments of the present disclosure, the conditional event represents an event used to evaluate the CHO execution condition. Alternatively, the conditional event represents an event used to evaluate whether to execute CHO.

In some embodiments, before S620, the terminal device receives the CHO configuration and/or the CHO execution condition from the network device. In some embodiments, the second information belongs to CHO configuration, and/or the first condition belongs to the CHO execution condition. In some embodiments, the network device transmitting the CHO configuration is a serving cell and/or a candidate cell and/or a neighbor cell of the terminal device. In some embodiments, the network device transmitting the CHO execution condition is a serving cell and/or a candidate cell and/or a neighbor cell of the terminal device.

In some embodiments, after receiving the CHO configuration, the terminal device starts to evaluate the CHO execution condition, that is, starts to evaluate whether the terminal device and the first cell satisfy the first condition.

In some embodiments, after receiving the CHO configuration, the terminal device starts to evaluate the CHO execution condition, that is, starts to evaluate whether the terminal device and the first cell satisfy the first condition and evaluate whether the second conditional event is satisfied.

In some embodiments, the terminal device performs the CHO from the serving cell to the first cell in the case where a first condition is continuously satisfied. That is, in the case where the terminal device remains within the coverage of the first cell within the first time period, the terminal device performs the CHO from the serving cell to the first cell. In some embodiments, the first time period is determined based on the measurement configuration.

In some embodiments, in the case where the second condition is continuously satisfied, the terminal device does not perform the CHO from the serving cell to the first cell. That is, in the case where the terminal device does not remain within the coverage of the first cell within the second time period, or the terminal device leaves the coverage of the first cell within the second time period, the terminal device does not perform the CHO from the serving cell to the first cell. In some embodiments, the second time period is determined based on the measurement configuration. In some embodiments, the second time period is the same as or different from the first time period.

In some embodiments, the serving cell and the first cell have a same frequency, or the serving cell and the first cell have different frequencies.

In some embodiments, the serving cell and the first cell belong to the same communication system, or the serving cell and the first cell belong to different communication systems.

In some embodiments, the serving cell belongs to a TN system; that is, the serving cell is a TN cell. The first cell belongs to an NTN system or a TN system; that is, the first cell is an NTN cell or a TN cell.

In some embodiments, the serving cell belongs to an NTN system; that is, the serving cell is an NTN cell. The first cell belongs to an NTN system or a TN system; that is, the first cell is an NTN cell or a TN cell.

In a scenario in which the serving cell is an NTN cell and the first cell is a TN cell, compared with the NTN cell, the TN cell has obvious advantages in terms of the transmission bandwidth, the cell capacity, the transmission delay, and the like, such that an improvement of the terminal device in the transmission quality due to acquisition of the TN cell as soon as possible is very beneficial to a communication service of the terminal device.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the handover from the serving cell to the first cell is considered as a CHO-type cell handover. In the case where the UE determines, based on the first information, that the UE enters the coverage of the first cell, the UE performs the CHO from the serving cell to the first cell. Therefore, in the method according to the embodiments of the present disclosure, it is ensured that the terminal device is handed over to the first cell as soon as possible, simplicity of the cell handover is further improved, and consumption of transmission resources required for the indication information and the measurement report is reduced.

In addition, a design in which the terminal device does not trigger the cell handover in the case where the second condition is satisfied is further provided, to avoid a case where the terminal device is mistakenly handed over to an inappropriate candidate cell. The cell handover condition of the terminal device is limited to ensure the transmission quality of the terminal device.

FIG. 7 illustrates a schematic flowchart of a cell handover method according to some exemplary embodiments of the present disclosure. The method is performed by a network device, and includes at least part of the following processes.

In S720, a first condition is configured for a terminal device.

In some embodiments, the first condition is used for the terminal device to perform an evaluation related to the cell handover, including one or more of an evaluation of measurement configuration, an evaluation of measurement reporting, an evaluation of a handover condition, and the like.

In some embodiments, the first condition is used for the terminal device to evaluate a candidate cell or a neighbor cell, and the candidate cell or the neighbor cell includes the first cell.

In some embodiments, the first condition is related to a neighbor cell or a candidate cell of the terminal device, which should also be understood as that the first condition is used to evaluate a measurement reporting condition of the terminal device that is associated with the neighbor cell or a handover condition of the terminal device that is associated with the candidate cell. The neighbor cell or the candidate cell of the terminal device includes the first cell.

In some embodiments, the first condition includes one or more of: a distance between the terminal device and the first cell being less than a first threshold; the distance between the terminal device and the first cell being equal to the first threshold; or the terminal device entering the coverage of the first cell.

In some embodiments, the first cell is also referred to as a target cell, and the serving cell is also referred to as a source cell.

In some embodiments, the first condition includes a case where a distance between the terminal device and the first cell is less than a first threshold, and/or the terminal device enters the coverage of the first cell.

In some embodiments, the first condition includes a case where a distance between the terminal device and the first cell is equal to a first threshold, and/or the terminal device enters the coverage of the first cell.

In some embodiments, the network device includes a network device corresponding to a serving cell of the terminal device. In some embodiments, the network device includes one or more of a satellite, an access network device, and an NTN gateway.

In summary, in the method according to the embodiments of the present disclosure, the first condition is used to evaluate the terminal device and the first cell. In this way, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like.

In some embodiments, S720 is implemented as S820. In some embodiments, the cell handover method further includes S840 and/or S860, as shown in FIG. 8. FIG. 8 illustrates a schematic flowchart of a cell handover method according to some exemplary embodiments of the present disclosure. The method is performed by a network device, and includes at least part of the following processes.

In S820, a first condition is configured for a terminal device.

In some embodiments, the first condition includes a case where a distance between the terminal device and a first cell is less than or equal to a first threshold. In some embodiments, the first threshold is configured by the network device, or defined by the communication protocol, or determined by the terminal device based on the configuration of the network device, or determined by the terminal device based on the communication protocol.

In some embodiments, the network device transmits measurement configuration to the terminal device. The measurement configuration includes at least one of the measurement object, the reporting configuration, the measurement identifier, or the measurement interval as described above.

In some embodiments, the first condition belongs to a trigger event.

In some embodiments, a measurement report is transmitted to the network device in the case where the terminal device and the first cell satisfy the first condition.

In some embodiments, the terminal device transmits the measurement report to the network device in the case where the terminal device and the first cell satisfy the first condition within a first time period.

In some embodiments, the trigger event is configured by the network device or defined by the communication protocol.

For related content of the trigger event, reference may be made to S320. Details are not described herein again.

In some embodiments, the first condition belongs to the first conditional event; that is, the first condition belongs to the CHO execution condition, and the handover from the serving cell to the first cell is the CHO.

In some embodiments, the first conditional event is configured by the network device or defined by the communication protocol.

For related content of the first conditional event, reference may be made to the embodiments shown in FIG. 4. Details are not described herein again.

In some embodiments, the handover from the serving cell to the first cell is performed in the case where the terminal device and the first cell satisfy the first condition.

In some embodiments, the handover from the serving cell to the first cell is performed in the case where the terminal device and the first cell satisfy the first condition within the first time period.

In some embodiments, the handover from the serving cell to the first cell is an event-triggered cell handover, or the handover from the serving cell to the first cell is the CHO.

In some embodiments, the network device further configures a second condition for the terminal device.

In some embodiments, the second condition is used for the terminal device to perform an evaluation related to the cell handover, including one or more of an evaluation of measurement configuration, an evaluation of measurement reporting, an evaluation of a handover condition, and the like.

In some embodiments, the second condition is used for the terminal device to evaluate a candidate cell or a neighbor cell, and the candidate cell or the neighbor cell includes the first cell.

In some embodiments, the second condition is related to a neighbor cell or a candidate cell of the terminal device, which should also be understood as that the second condition is a handover condition used to evaluate the terminal device with a neighbor cell or a candidate cell. The neighbor cell or the candidate cell of the terminal device includes the first cell.

In some embodiments, the second condition includes a case where a distance between the terminal device and the first cell is greater than or equal to a second threshold. In some embodiments, the second threshold is configured by the network device, or defined by the communication protocol, or determined by the terminal device based on the configuration of the network device, or determined by the terminal device based on the communication protocol.

In some embodiments, the second condition belongs to a trigger event or a first conditional event.

In some embodiments, both the first condition and the second condition belong to trigger events. In some embodiments, the first condition is an entry condition for the trigger event, and the second condition is an exit condition for the trigger event.

In some embodiments, the terminal device performs the first processor the second process in the case where the terminal device and the first cell satisfy a second condition. For related content of the first process, reference may be made to S360. For related content of the second process, reference may be made to S560. Details are not described herein again.

In some embodiments, in the case where the terminal device and the first cell satisfy the second condition within a second time period, the measurement report is not transmitted to the network device.

In some embodiments, both the first condition and the second condition belong to the first conditional event. In some embodiments, the first condition is an entry condition for the first conditional event, and the second condition is an exit condition for the first conditional event.

In some embodiments, in the case where the terminal device and the first cell satisfy the second condition, the handover from the serving cell to the first cell is not performed.

In some embodiments, in the case where the terminal device and the first cell satisfy the second condition within the second time period, the handover from the serving cell to the first cell is not performed.

In some embodiments, the second condition includes a case where a distance between the terminal device and the first cell is greater than or equal to a second threshold. In some embodiments, the second threshold is configured by the network device, or defined by the communication protocol, or determined by the terminal device based on the configuration of the network device, or determined by the terminal device based on the communication protocol.

In some embodiments, the network device further configures a second conditional event for the terminal device. The second conditional event includes a CHO execution condition corresponding to the first cell, other than a first conditional event.

In some embodiments, the network device transmits CHO configuration and/or the CHO execution condition to the terminal device. The first condition belongs to the CHO execution condition.

In some embodiments, the network device further configures second information for the terminal device. For related content of the second information, reference may be made to S520. Details are not described herein again.

In S840, first information from the terminal device is received.

In some embodiments, the first information includes a measurement report, and the measurement report is used to indicate that a distance between the terminal device and the first cell is less than or equal to a first threshold.

In some embodiments, the measurement report further includes a measurement result of the serving cell and/or a measurement result of the first cell.

In some embodiments, the first threshold is configured by the network device, or defined by the communication protocol, or determined by the terminal device based on the configuration of the network device, or determined by the terminal device based on the communication protocol.

In some embodiments, the first information includes first indication information, and the first indication information is used to indicate that the terminal device enters the coverage of the first cell.

In S860, second indication information is transmitted to the terminal device, wherein the second indication information is used to indicate that the terminal device is handed over from the serving cell to the first cell.

In some embodiments, the second indication information is determined by the network device at least based on the measurement report.

In some embodiments, the second indication information is determined by the network device at least based on the first indication information.

In some embodiments, the serving cell and the first cell have a same frequency, or the serving cell and the first cell have different frequencies.

In some embodiments, the serving cell and the first cell belong to the same communication system, or the serving cell and the first cell belong to different communication systems.

In some embodiments, the serving cell belongs to a TN system; that is, the serving cell is a TN cell. The first cell belongs to an NTN system or a TN system; that is, the first cell is an NTN cell or a TN cell.

In some embodiments, the serving cell belongs to an NTN system; that is, the serving cell is an NTN cell. The first cell belongs to an NTN system or a TN system; that is, the first cell is an NTN cell or a TN cell.

In a scenario in which the serving cell is an NTN cell and the first cell is a TN cell, compared with the NTN cell, the TN cell has obvious advantages in terms of the transmission bandwidth, the cell capacity, the transmission delay, and the like, such that an improvement of the terminal device in the transmission quality due to acquisition of the TN cell as soon as possible is very beneficial to a communication service of the terminal device.

In summary, in the method according to the embodiments of the present disclosure, the first condition is used to evaluate the terminal device and the first cell. In this way, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, a design of the first information and the second indication information is further provided. In the case where the first information and the second indication information are transmitted, accuracy and rationality of the cell handover are ensured. In the case where the first information and the second indication information are not transmitted, simplicity of the cell handover is improved, and consumption of transmission resources required for the indication information and the measurement report is reduced.

In addition, a design of the second condition is further provided, to avoid a case where the terminal device is mistakenly handed over to an inappropriate candidate cell. The cell handover condition of the terminal device is limited to ensure the transmission quality of the terminal device.

For the trigger event in FIG. 3, FIG. 5, or FIG. 8, a trigger event design is illustratively provided herein. In some embodiments, the trigger event in FIG. 3, FIG. 5, or FIG. 8 is named as Event D2, or another name that represents a trigger event, for example, Event D3, or Event D4.

Trigger event (Event D2): A distance from the terminal device to a reference location is less than a threshold.

A first condition for a trigger event (Event D2) (i.e., an entry condition for the trigger event): Ml+Hys<Thresh. In the formula, Ml represents the distance between the terminal device and the reference location described above, that is, represents the distance between the terminal device and a TN cell; Hys represents a first parameter, and the first parameter value described above is the value of Hys, and the first parameter is also referred to as a hysteresis parameter; and Thresh represents the third threshold described above.

A second condition for the trigger event (Event D2) (i.e., an exit condition for the trigger event): Ml−Hys>Thresh.

It should be noted that the first condition for the trigger event (Event D2) may also be Ml<Thresh, and the second condition may also be Ml>Thresh. In the present disclosure, an example where the first condition is Ml+Hys<Thresh and the second condition is Ml−Hys>Thresh is used for description.

Exemplarily, EventTriggerConfig in ReportConfigNR is extended as follows:

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
    ]]
  [[
```

| | |
|---|---|
| eventD2-r19 | SEQUENCE { |
| distanceThreshFromReference-r17 | INTEGER(1.. 65525), |
| referenceLocation-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
    }
  ]]
  },
```

Next, a cell handover method based on a trigger event (Event D2) is introduced. As shown in FIG. 9, the method is performed by a terminal device and a network device, and the method includes at least part of the following processes.

In S901, the network device transmits measurement configuration to the terminal device, wherein the measurement configuration includes a trigger event.

The embodiments of the present disclosure are illustrated taking an example where the serving cell of the terminal device includes an NTN cell and the first cell includes a TN cell.

In some embodiments, the measurement configuration is carried by RRC reconfiguration information.

In some embodiments, the measurement configuration includes at least one of the measurement object, the reporting configuration, the measurement identifier, or the measurement interval as described above. A trigger event (Event D2) is configured. In some embodiments, the measurement configuration further includes another measurement event. The configuration of Event D2 includes at least one of: a reference location; a first parameter value; or a third threshold.

Exemplarily, the reference location is indicated by referenceLocation in reportConfigNR. The reference location is, for example, a central location of the TN cell, or a location of the network device of the TN cell.

Exemplarily, the first parameter value is indicated by hysteresisLocation in reportConfigNR. The first parameter value is the value of the first parameter. In some embodiments, the first parameter may also be referred to as a hysteresis parameter Hys.

Exemplarily, the third threshold is indicated by distanceThreshFromReference in reportConfigNR. In some embodiments, the third threshold is represented by Thresh.

In S902, the terminal device transmits a measurement report to the network device in the case where a first condition is satisfied.

Exemplarily, the first condition includes an entry condition for a trigger event (Event D2); that is, a sum of the first parameter value and the distance between the terminal device and the reference location is less than a third threshold, that is, Ml+Hys<Thresh. It should be understood that the first condition may also be modified based on mathematical principles as follows: the distance between the terminal device and the reference location is less than the difference between the third threshold and the first parameter value, that is, M<Thresh-Hys.

In some embodiments, the terminal device transmits the measurement report to the network device in the case where the first condition is continuously satisfied. That is, the terminal device reports the measurement report to the network device after a trigger event (Event D2) entry condition is satisfied and lasts for the first time period. In some embodiments, the first time period is determined based on the measurement configuration. In some embodiments, the first time period is referred to as timeToTrigger.

In some embodiments, whether the first condition is satisfied is determined by the terminal device based on location information of the terminal device. The location information of the terminal device includes absolute location information and/or relative location information of the terminal device.

The measurement report is used to indicate that the terminal device satisfies the first condition; that is, the measurement report is used to indicate that the sum of the first parameter value and the distance between the terminal device and the reference location is less than the third threshold. In some embodiments, the measurement report further includes a measurement result of a serving cell of the terminal device, and/or a measurement result of a candidate cell, and/or a measurement result of a neighbor cell of the terminal device.

In S903, the network device transmits second indication information to the terminal device.

The second indication information is used to indicate that the terminal device is handed over from a serving cell to a first cell, for example, handed over from an NTN cell to a TN cell.

The network device determines a target cell based on the received measurement report. Alternatively, the network device determines the target cell based on the location information of the terminal device and the measurement report.

In some embodiments, after receiving the measurement reporting, the network device determines, in combination with location-related reporting (at least one of location information of the terminal device, location information of a serving cell, location information of a neighbor cell, location information of a candidate cell, or the like) and signal quality-related reporting (at least one of a measurement result of the serving cell, a measurement result of the neighbor cell, a measurement result of the candidate cell, or the like), that the terminal device performs the handover from the NTN cell to the TN cell, and transmits the second indication information to the terminal device after negotiation by the network device.

Exemplarily, the measurement report reported by the terminal device includes measurement results of NTN cell 1 (a source cell or a serving cell), NTN cell 2, TN cell 1, and TN cell 2. In the case where the measurement result of TN cell 1 is optimal, and/or the terminal device is closest to TN cell 1, and/or the terminal device enters the coverage of TN cell 1, the network device determines that the target cell is TN cell 1. The first indication information from the network device is used to indicate that the terminal device is handed over from NTN cell 1 to TN cell 1.

In S904, the terminal device performs a cell handover based on the second indication information.

In some embodiments, the terminal device is handed over from the serving cell to the first cell based on the second indication information, for example, handed over from an NTN cell to a TN cell.

It should be understood that the design of the trigger event (Event D2) is also applicable to cell handover scenarios other than the cell handover from the NTN cell to the TN cell. That is, in a scenario of the cell handover based on a trigger event (Event D2), the source cell is not necessarily an NTN cell, and the target cell is not necessarily a TN cell. Regardless of a communication network to which the source cell and the target cell belong, a design of the trigger event (Event D2) enables the UE to be handed over as soon as possible to a target cell that satisfies requirements and whose transmission quality is ensured.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the first condition belongs to a trigger event, and the handover from the serving cell to the first cell is considered as an event-triggered cell handover. In the case where the UE is close enough to the first cell, reporting of the measurement report is triggered, such that the network device delivers a cell handover indication in time, and thus the UE is handed over from the serving cell to the first cell as soon as possible. Therefore, in the method according to the embodiments of the present disclosure, it is ensured that the terminal device is handed over to the first cell as soon as possible, and accuracy and rationality of the cell handover are ensured by reporting the measurement report.

For the first conditional event in FIG. 4, FIG. 6, or FIG. 8, a design of the first conditional event is illustratively provided herein. In some embodiments, the first conditional event in FIG. 4, FIG. 6, or FIG. 8 is named as CondEvent D2, or another name that represents a conditional event, for example, CondEvent D3 or CondEvent D4.

A first conditional event (CondEvent D2): A distance from the UE to a reference location of a conditional reconfiguration candidate cell is less than a threshold.

The first condition for the first conditional event (CondEvent D2)(i.e., the entry condition for the first conditional event): Ml+Hys<Thresh. In the formula, Ml represents the distance between the terminal device and the reference location described above, that is, represents the distance between the terminal device and a TN cell; Hys represents a first parameter, and the first parameter value described above is the value of Hys, and the first parameter is also referred to as a hysteresis parameter; and Thresh represents the third threshold described above.

The second condition for the first conditional event (CondEvent D2) (i.e., the exit condition for the trigger event): Ml−Hys>Thresh.

It should be noted that the first condition for the first conditional event (CondEvent D2) may also be MW<Thresh, and the second condition may also be Ml>Thresh. In the present disclosure, an example where the first condition is Ml+Hys<Thresh and the second condition is Ml−Hys>Thresh is used for description.

Exemplarily, CondTriggerConfig in ReportConfigNR is extended as follows:

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
      },
      ...,
      [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16 |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525), |
| referenceLocation1-r17 | ReferenceLocation-r17, |
| referenceLocation2-r17 | ReferenceLocation-r17, |
| repotOnLeave-r17 | BOOLEAN, |
| hysteresisLocation-r17 | HysteresisLocation-r17, |
| timeToTrigger-r17 | TimeToTrigger |

```
      }
      ]]
    [[
```

| | |
|---|---|
| condEventD2-r19 | SEQUENCE { |
| distanceThreshFromReference-r17 | INTEGER(1.. 65525), |
| referenceLocation-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

```
      }
    ]]
  },
```

| | |
|---|---|
| rsType-r16 | NR-RS-Type, |

```
  ...
  }
```

The following describes a cell handover method based on a first conditional event (CondEvent D2). As shown in FIG. 10, the method is performed by a terminal device and a network device, and includes at least part of the following processes.

In S1001, the network device transmits measurement configuration to the terminal device, wherein the measurement configuration includes a first conditional event.

The embodiments of the present disclosure are illustrated taking an example where the serving cell of the terminal device includes an NTN cell and the first cell includes a TN cell.

In some embodiments, the measurement configuration is carried by RRC reconfiguration information.

In some embodiments, the measurement configuration includes at least one of the measurement object, the reporting configuration, the measurement identifier, or the measurement interval as described above. A first conditional event (CondEvent D2) is configured. In some embodiments, the measurement configuration further includes another measurement event. The configuration of the first conditional event (CondEvent D2) includes at least one of: a reference location, a first parameter value, or a third threshold.

Exemplarily, the reference location is indicated by referenceLocation in reportConfigNR. The reference location is, for example, a central location of a CHO candidate TN cell or a location of a network device of the CHO candidate TN cell.

Exemplarily, the first parameter value is indicated by hysteresisLocation in reportConfigNR. The first parameter value is the value of the first parameter. In some embodiments, the first parameter may also be referred to as a hysteresis parameter Hys.

Exemplarily, the third threshold is indicated by distanceThreshFromReference in reportConfigNR. In some embodiments, the third threshold is represented by Thresh.

In S1002, the terminal device performs CHO in the case where a first condition is satisfied.

In some embodiments, the terminal device performs the CHO from the serving cell to the first cell, for example, the CHO from an NTN cell to a TN cell, in the case where a sum of the first parameter value and the distance between the terminal device and the reference location is less than a third threshold.

Exemplarily, the first condition includes an entry condition for a first conditional event (CondEvent D2); that is, a sum of the first parameter value and the distance between the terminal device and the reference location is less than the third threshold, that is, Ml+Hys<Thresh. It should be understood that the first condition may also be modified based on mathematical principles as follows: the distance between the terminal device and the reference location is less than the difference between the third threshold and the first parameter value, that is, Ml<Thresh-Hys.

In some embodiments, the terminal device performs CHO from the NTN cell to the TN cell in the case where the first condition is continuously satisfied. That is, the terminal device performs the CHO from the NTN cell to the TN cell after the entry condition for the first conditional event (CondEvent D2) is satisfied and lasts for a second time period. In some embodiments, the second time period is determined based on the measurement configuration. In some embodiments, the second time period is referred to as timeToTrigger.

In some embodiments, whether the first condition is satisfied is determined by the terminal device based on location information of the terminal device. The location information of the terminal device includes absolute location information and/or relative location information of the terminal device.

Exemplarily, the terminal device measures NTN cell 1 (a source cell or a serving cell), NTN cell 2, TN cell 1, and TN cell 2 based on the measurement configuration. In the case where the measurement result of TN cell 1 is optimal, and/or the terminal device is closest to TN cell 1, and/or the terminal device enters the coverage of TN cell 1, the terminal device determines that the target cell is TN cell 1, and performs CHO from NTN cell to TN cell.

In some embodiments, the terminal device performs the CHO from the NTN cell to the TN cell in the case where the first condition is satisfied and the entry condition for the second conditional event is satisfied. The second conditional event includes a CHO execution condition corresponding to the TN cell, other than a first conditional event. Exemplarily, the second conditional event includes at least one of CondEvent A3, CondEvent A4, CondEvent A5, or the like. The second conditional event is configured by the network device or defined by a communication protocol.

In some embodiments, the terminal device performs the CHO from the NTN cell to the TN cell in the case where the first condition is continuously satisfied and the entry condition for the second conditional event is satisfied.

It should be understood that the design of the first conditional event (CondEvent D2) is also applicable to cell handover scenarios other than the cell handover from the NTN cell to the TN cell. That is, the source cell of the cell handover based on the first conditional event (CondEvent D2) is not necessarily an NTN cell, and the target cell is not necessarily a TN cell. Regardless of a communication network to which the source cell and the target cell belong, a design of the first conditional event (CondEvent D2) enables the UE to be handed over as soon as possible to a target cell that satisfies requirements and whose transmission quality is ensured.

In summary, in the method according to the embodiments of the present disclosure, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like. In addition, the handover from the serving cell to the first cell may be considered as a CHO-type cell handover. In the case where the UE determines, based on the first information, that the UE enters the coverage of the first cell, the UE performs the CHO from the serving cell to the first cell. Therefore, in the method according to the embodiments of the present disclosure, it is ensured that the terminal device is handed over to the first cell as soon as possible, simplicity of the cell handover is further improved, and consumption of transmission resources required for the indication information and the measurement report is reduced.

FIG. 11 illustrates a schematic flowchart of a cell handover method according to some exemplary embodiments of the present disclosure. The method is performed by a terminal device and a network device, and includes at least part of the following processes.

In S1101, the network device configures second information for the terminal device.

The second information is used by the terminal device to evaluate whether the terminal device satisfies the first condition. For example, the second information is used by the terminal device to evaluate whether the terminal device enters the coverage of the first cell.

For related content of the second information, reference may be made to S520. Details are not described herein again.

In some embodiments, the second information is also referred to as fingerprint information, or referred to as assistance information.

In some embodiments, the second information is transmitted through RRC dedicated signaling.

In S1102, the terminal device transmits first indication information to the network device in the case where the terminal device detects the second information.

For related content of the first indication information, reference may be made to S520. Details are not described herein again.

In S1103, the network device transmits second indication information to the terminal device.

The network device transmits the second indication information based on the received first indication information. Alternatively, the network device transmits the second indication information based on location information of the terminal device and the first indication information.

In some embodiments, the first indication information is transmitted through RRC signaling or MAC signaling.

In S1104, the terminal device performs a cell handover based on the second indication information.

In some embodiments, the terminal device is handed over from the serving cell to the first cell based on the second indication information, for example, handed over from an NTN cell to a TN cell.

It should be understood that the design of the second information is also applicable to cell handover scenarios other than the cell handover from the NTN cell to the TN cell. That is, in a cell handover scenario based on the second information, the source cell is not necessarily an NTN cell, and the target cell is not necessarily a TN cell. Regardless of a communication network to which the source cell and the target cell belong, a design of the second information enables the UE to be handed over as soon as possible to a target cell that satisfies requirements and whose transmission quality is ensured.

In summary, in the method according to the embodiments of the present disclosure, the terminal device and the first cell are evaluated by using the first condition determined based on the second information, and the terminal device is handed over to the first cell more quickly without considering the distance between the UE and the serving cell, such that the transmission quality is improved as early as possible by using advantages of the first cell in terms of the transmission bandwidth, the cell capacity, and the transmission delay. In addition, the introduction of the first indication information ensures that the terminal device is handed over to the first cell as soon as possible, and further ensures accuracy and rationality of the cell handover by reporting the first indication information.

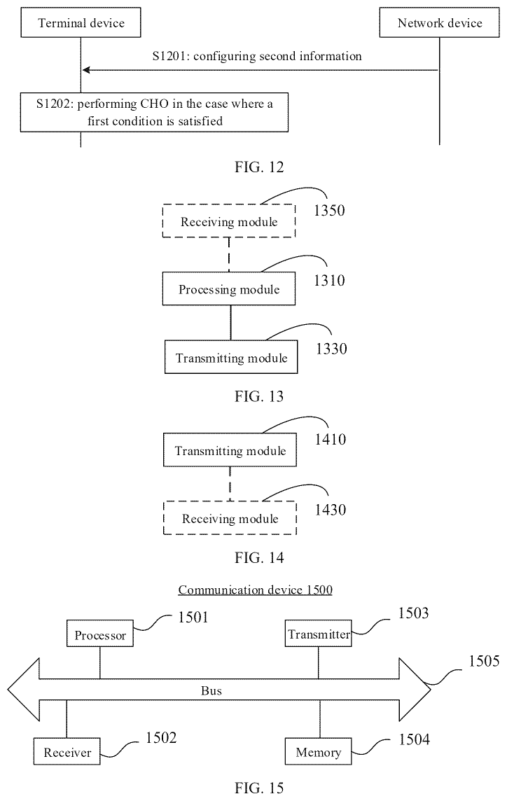

FIG. 12 illustrates a schematic flowchart of a cell handover method according to some exemplary embodiments of the present disclosure. The method is performed by a terminal device and a network device, and includes at least part of the following processes.

In S1201, the network device configures second information for the terminal device.

The second information is used by the terminal device to evaluate whether the terminal device satisfies the first condition. For example, the second information is used by the terminal device to evaluate whether the terminal device enters the coverage of the first cell.

For related content of the second information, reference may be made to S520. Details are not described herein again.

In some embodiments, the second information is also referred to as fingerprint information, or referred to as assistance information.

In some embodiments, the second information is transmitted through RRC dedicated signaling.

In S1202, the terminal device performs the CHO from an NTN cell to a TN cell in the case where the terminal device detects first information.

In some embodiments, in the case where the first information is detected, the terminal device performs the CHO from a serving cell to the first cell, for example, the CHO from the NTN cell to the TN cell.

It should be understood that the design of the second information is also applicable to cell handover scenarios other than the cell handover from the NTN cell to the TN cell. That is, in a cell handover scenario based on the second information, the source cell is not necessarily an NTN cell, and the target cell is not necessarily a TN cell. Regardless of a communication network to which the source cell and the target cell belong, a design of the second information enables the UE to be handed over as soon as possible to a target cell that satisfies requirements and whose transmission quality is ensured.

In summary, in the method according to the embodiments of the present disclosure, the terminal device and the first cell are evaluated by using the first condition determined based on the second information, and the terminal device is handed over to the first cell more quickly without considering the distance between the UE and the serving cell, such that the transmission quality is improved as early as possible by using advantages of the first cell in terms of the transmission bandwidth, the cell capacity, and the transmission delay. In addition, simplicity of the cell handover is improved, and consumption of transmission resources required for indication information and a measurement report is reduced.

FIG. 13 illustrates a structural block diagram of a cell handover apparatus according to some exemplary embodiments of the present disclosure. The apparatus may be implemented as the apparatus shown in FIG. 2, FIG. 3, FIG. 4, FIG. 5, FIG. 6, FIG. 9, FIG. 10, FIG. 11, or FIG. 12, or as a part of the apparatus shown in FIG. 2, FIG. 3, FIG. 4, FIG. 5, FIG. 6, FIG. 9, FIG. 10, FIG. 11, or FIG. 12. The apparatus includes a processing module 1310 and/or a transmitting module 1330. In some embodiments, the apparatus further includes a receiving module 1350.

The transmitting module 1330 is configured to transmit first information to a network device in the case where the apparatus and a first cell satisfy a first condition; and/or

the processing module 1310 is configured to perform a handover from a serving cell to the first cell in the case where the apparatus and the first cell satisfy the first condition.

In some embodiments, the first condition includes at least one of: a distance between the apparatus and the first cell being less than a first threshold; the distance between the apparatus and the first cell being equal to a first threshold; or the apparatus entering the coverage of the first cell.

In some embodiments, the first condition belongs to a trigger event.

In some embodiments, the first information includes a measurement report.

In some embodiments, the transmitting module 1330 is further configured to transmit the measurement report to the network device in the case where the distance between the apparatus and the first cell is less than the first threshold, wherein the measurement report is used to indicate that the distance between the apparatus and the first cell is less than the first threshold.

In some embodiments, the transmitting module 1330 is further configured to transmit the measurement report to the network device in the case where the distance between the terminal device and the first cell is less than or equal to the first threshold within a first time period.

In some embodiments, the processing module 1310 is further configured to add a first measurement report entry to a measurement report list variable.

In some embodiments, the measurement report further includes at least one of a measurement result of the serving cell or a measurement result of the first cell.

In some embodiments, the first condition belongs to a first conditional event.

In some embodiments, the processing module 1310 is further configured to: perform a conditional handover CHO from the serving cell to the first cell in the case where the distance between the apparatus and the first cell is less than or equal to the first threshold; or
perform CHO from the serving cell to the first cell in the case where the distance between the apparatus and the first cell is less than or equal to the first threshold and a second conditional event is satisfied;
wherein the second conditional event includes a CHO execution condition corresponding to the first cell, other than a first conditional event.

In some embodiments, the processing module 1310 is further configured to: perform CHO from the serving cell to the first cell in the case where the distance between the terminal device and the first cell within a first time period is less than or equal to the first threshold and the second conditional event is satisfied within the first time period.

In some embodiments, the transmitting module 1330 is further configured to: refrain from transmitting, in the case where the apparatus and the first cell satisfy a second condition, the first information to the network device;
and/or, the processing module 1310 is further configured to: refrain from performing, in the case where the apparatus and the first cell satisfy the second condition, the handover from the serving cell to the first cell.

In some embodiments, the processing module 1310 and/or the transmitting module 1330 is further configured to perform a first process in the case where the terminal device and the first cell satisfy the second condition.

In some embodiments, the first process includes at least one of:
deleting a first measurement report entry from a measurement report list variable;
refraining from transmitting the first information to the network device;
refraining from performing the handover from the serving cell to the first cell;
transmitting second information to the network device, wherein the second information is used to indicate that the terminal device satisfies the second condition; or
transmitting second information to the network device, wherein the second information is used to indicate that the terminal device does not satisfy the first condition.

In some embodiments, the processing module 1310 and/or the transmitting module 1330 is further configured to perform the first process in the case where the terminal device and the first cell satisfy the second condition within a second time period.

In some embodiments, the second condition includes at least one of: a distance between the apparatus and the first cell being greater than or equal to a second threshold; or the apparatus not entering the coverage of the first cell.

In some embodiments, the second condition includes a case where the distance between the apparatus and the first cell is greater than or equal to the second threshold.

In some embodiments, the second condition belongs to a trigger event, or the second condition belongs to a first conditional event.

In some embodiments, configuration information of the trigger event includes at least one of: a reference location; a first parameter value; or a third threshold;
wherein a first threshold is the third threshold, or a first threshold is a difference between the third threshold and the first parameter value; and a second threshold is the third threshold, or a second threshold is a sum of the third threshold and the first parameter value.

In some embodiments, the configuration information of the first conditional event includes at least one of: a reference location, a first parameter value, or a third threshold; wherein a first threshold is the third threshold, or a first threshold is a difference between the third threshold and the first parameter value; and
a second threshold is the third threshold, or a second threshold is a sum of the third threshold and the first parameter value.

In some embodiments, a distance between the apparatus and the first cell is a distance between the apparatus and the first reference location.

In some embodiments, the trigger event is configured by the network device or defined by the communication protocol.

In some embodiments, the first conditional event is configured by the network device or defined by the communication protocol.

In some embodiments, the apparatus entering the coverage of the first cell is determined based on second information.

In some embodiments, the second information includes at least one of: a measurement result of at least one candidate cell, the measurement result of the at least one candidate cell being associated with the coverage of the first cell; a measurement result of at least one beam, the measurement result of the at least one beam being associated with the coverage of the first cell; non-cellular wireless information; or location information of the first cell.

In some embodiments, the non-cellular wireless information includes at least one of: information carried by a WLAN signal; information indicated by a WLAN signal; information carried by a Wi-Fi signal; information indicated by a Wi-Fi signal; information carried by a Bluetooth signal; information indicated by a Bluetooth signal; information carried by a radar signal; or information indicated by a radar signal.

In some embodiments, the second information is configured by the network device or defined by the communication protocol.

In some embodiments, the first condition includes the apparatus entering the coverage of the first cell.

In some embodiments, the first information includes first indication information.

In some embodiments, the transmitting module 1330 is further configured to: transmit, in the case where the apparatus enters the coverage of the first cell, first indication information to the network device, and the first indication information is used to indicate that the apparatus enters the coverage of the first cell.

In some embodiments, the transmitting module 1330 is further configured to: transmit, in the case where the apparatus remains within the coverage of the first cell within a first time period, the first indication information to the network device.

In some embodiments, the processing module 1310 is further configured to: perform CHO from the serving cell to the first cell in the case where the apparatus enters the coverage of the first cell; or
perform CHO from the serving cell to the first cell in the case where the apparatus enters the coverage of the first cell and a second conditional event is satisfied;
wherein the second conditional event includes a CHO execution condition corresponding to the first cell, other than a first conditional event.

In some embodiments, the processing module 1310 is further configured to: perform CHO from the serving cell to the first cell in the case where the apparatus remains within the coverage of the first cell within the first time period.

In some embodiments, the processing module 1310 is further configured to: perform CHO from the serving cell to the first cell in the case where the apparatus remains within the coverage of the first cell within a first time period and a second conditional event is satisfied within the first time period.

In some embodiments, the first cell includes an NTN cell or a TN cell.

In summary, the apparatus according to the embodiments of the present disclosure, the apparatus and the first cell are evaluated by using the first condition. In the case where the apparatus and the first cell satisfy the first condition, an operation related to the cell handover is performed without waiting for the preset condition to be satisfied by the UE and the serving cell, such that the apparatus is handed over to the first cell more quickly, thereby improving the transmission quality as soon as possible by using advantages of the first cell in terms of the transmission bandwidth, the cell capacity, the transmission delay, and the like.

FIG. 14 illustrates a structural block diagram of a cell handover apparatus according to some exemplary embodiments of the present disclosure. The apparatus may be implemented as the apparatus shown in FIG. 7, FIG. 8, FIG. 9, FIG. 10, FIG. 11, or FIG. 12, or may be implemented as a part of the apparatus shown in FIG. 7, FIG. 8, FIG. 9, FIG. 10, FIG. 11, or FIG. 12. The apparatus includes a transmitting module 1410. In some embodiments, the apparatus further includes a receiving module 1430.

The transmitting module 1410 is configured to configure a first condition for a terminal device, wherein the first condition is used to evaluate the terminal device and a first cell.

In some embodiments, the first condition includes at least one of: a distance between the terminal device and the first cell being less than a first threshold; the distance between the terminal device and the first cell being equal to a first threshold; or the terminal device entering the coverage of the first cell.

In some embodiments, the apparatus further includes a receiving module 1430 configured to receive first information from the terminal device.

In some embodiments, the first condition belongs to a trigger event.

In some embodiments, the receiving module 1430 is further configured to receive a measurement report from the terminal device, wherein the measurement report is used to indicate that the distance between the terminal device and the first cell is less than the first threshold.

In some embodiments, the first condition belongs to a first conditional event.

In some embodiments, the transmitting module 1410 is further configured to configure a second conditional event for the terminal device, wherein the second conditional event includes a CHO execution condition corresponding to the first cell, other than the first conditional event.

In some embodiments, the transmitting module 1410 is further configured to configure a second condition for the terminal device.

In some embodiments, the second condition includes at least one of: a distance between the terminal device and the first cell being greater than or equal to a second threshold; or the terminal device not entering the coverage of the first cell.

In some embodiments, the second condition includes a case where the distance between the terminal device and the first cell is greater than or equal to a second threshold.

In some embodiments, the second condition belongs to a trigger event, or the second condition belongs to a first conditional event.

In some embodiments, configuration information of the trigger event includes at least one of: a reference location; a first parameter value; or a third threshold;
wherein a first threshold is the third threshold, or a first threshold is a difference between the third threshold and the first parameter value; and a second threshold is the third threshold, or a second threshold is a sum of the third threshold and the first parameter value.

In some embodiments, the configuration information of the first conditional event includes at least one of: a reference location; a first parameter value; or a third threshold; wherein the first threshold is the third threshold, or the first threshold is a difference between the third threshold and the first parameter value; and the second threshold is the third threshold, or the second threshold is a sum of the third threshold and the first parameter value.

In some embodiments, the distance between the terminal device and the first cell is a distance between the terminal device and the reference location.

In some embodiments, the terminal device entering the coverage of the first cell is determined based on second information.

In some embodiments, the second information includes at least one of: a measurement result of at least one candidate cell, the measurement result of the at least one candidate cell being associated with the coverage of the first cell; a measurement result of at least one beam, the measurement result of the at least one beam being associated with the coverage of the first cell; non-cellular wireless information; or location information of the first cell.

In some embodiments, the non-cellular wireless information includes at least one of: information carried by a WLAN signal; information indicated by a WLAN signal; information carried by a Wi-Fi signal; information indicated by a Wi-Fi signal; information carried by a Bluetooth signal; information indicated by a Bluetooth signal; information carried by a radar signal; or information indicated by a radar signal.

In some embodiments, the transmitting module 1410 is further configured to configure the second information for the terminal device.

In some embodiments, the receiving module 1430 is further configured to receive first indication information from the terminal device, wherein the first indication information is used to indicate that the terminal device enters the coverage of the first cell.

In some embodiments, the transmitting module 1410 is further configured to transmit second indication information to the terminal device, wherein the second indication information is used to indicate that the terminal device is handed over from the serving cell to the first cell.

In some embodiments, the first cell includes an NTN cell or a TN cell.

In summary, in the apparatus according to the embodiments of the present disclosure, the first condition is used to evaluate the terminal device and the first cell. In this way, the terminal device performs the operation related to the cell handover in the case where the terminal device and the first cell satisfy the first condition, without waiting for the preset condition to be satisfied by the UE and the serving cell, such that the terminal device is handed over to the first cell more quickly, thereby improving the transmission quality as early as possible by using advantages of the first cell in terms of the transmission bandwidth, the cell capacity, the transmission delay, and the like.

FIG. 15 illustrates a schematic structural diagram of a communication device 1500 according to some exemplary embodiments of the present disclosure. The communication device includes: a processor 1501, a receiver 1502, a transmitter 1503, a memory 1504, and a bus 1505. The communication device 1500 is configured to perform at least some processes performed by the terminal device shown in FIG. 2, FIG. 3, FIG. 4, FIG. 5, FIG. 6, FIG. 9, FIG. 10, FIG. 11, or FIG. 12, or is configured to perform at least some processes performed by the network device shown in FIG. 7, FIG. 8, FIG. 9, FIG. 10, FIG. 11, or FIG. 12.

The processor 1501 includes one or more processing cores, and the processor 1501 performs various functional applications and information processing by running software programs and modules. In some embodiments, the processor 1501 is configured to implement the functions and processes of the processing module 1310 described above.

The receiver 1502 and the transmitter 1503 are practiced as a communication assembly, which may be a communication chip and may be referred to as a transceiver. In some embodiments, the receiver 1502 is configured to implement the functions and processes of the receiving module 1350 and/or the receiving module 1430 as described above, and the transmitter 1503 is configured to implement the functions and processes of the transmitting module 1330 and/or the transmitting module 1410 as described above.

The memory 1504 is connected to the processor 1501 by the bus 1505.

The memory 1504 is configured to store at least one instruction, and the processor 1501 is configured to load and execute the at least one instruction to perform the processes in the above method embodiments.

In addition, the memory 1504 may be implemented by any type or combination of volatile or non-volatile storage devices including, but not limited to: magnetic or optical disks, electrically-erasable programmable read-only memories (EEPROMs), erasable programmable read-only memories (EPROMs), static random access memories (SRAMs), read-only memories (ROMs), magnetic memories, flash memories, and programmable read-only memories (PROMs).

In some embodiments, the receiver 1502 independently receives signals/data, or the processor 1501 controls the receiver 1502 to receive signals/data, or the processor 1501 requests the receiver 1502 to receive signals/data, or the processor 1501 cooperates with the receiver 1502 to receive signals/data.

In some embodiments, the transmitter 1503 independently transmits signals/data, or the processor 1501 controls the transmitter 1503 to transmit signals/data, or the processor 1501 requests the transmitter 1503 to transmit signals/data, or the processor 1501 cooperates with the transmitter 1503 to transmit signals/data.

In some exemplary embodiments of the present disclosure, a computer-readable storage medium is further provided. The computer-readable storage medium stores one or more programs. The one or more programs, when loaded and run by the processor, cause the processor to perform the cell handover method according to the above method embodiments.

In some exemplary embodiments of the present disclosure, a chip is further provided. The chip includes programmable logic circuitry and/or one or more program instructions. The chip, when running on a communication device, is caused to perform the cell handover method according to the above method embodiments.

In some exemplary embodiments of the present disclosure, a computer program product is further provided. The computer program product, when running on a processor of a computer device, causes the computer device to perform the above cell handover method.

In some exemplary embodiments of the present disclosure, a computer program is further provided. The computer program includes one or more computer instructions. The one or more computer instructions, when loaded and executed by a processor of a computer device, cause the computer device to perform the above cell handover method.

It should be understood by those of ordinary skill in the art that all or a part of the processes for implementing the above embodiments are completed by hardware, or are completed by instructing relevant hardware by a program stored in a computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalent substitutions, improvements, and the like, made within the spirit and principle of the present disclosure should fall within the scope of protection of the present disclosure.

1. A cell handover method, performed by a terminal device, the method comprising:
transmitting first information to a network device and/or performing a handover from a serving cell to a first cell in a case where the terminal device and the first cell satisfy a first condition.

2. The method according to claim 1, wherein the first condition comprises at least one of:
a distance between the terminal device and the first cell being less than a first threshold;
a distance between the terminal device and the first cell being equal to a first threshold; or
the terminal device entering a coverage of the first cell.

3. The method according to claim 2, wherein:
the first condition comprises the distance between the terminal device and the first cell being less than or equal to the first threshold, and the first information comprises a measurement report; and
transmitting the first information to the network device in the case where the terminal device and the first cell satisfy the first condition comprises:
transmitting the measurement report to the network device in a case where the distance between the terminal device and the first cell is less than or equal to the first threshold or in a case where the distance between the terminal device and the first cell is less than or equal to the first threshold within a first time period, wherein the measurement report is used to indicate that the distance between the terminal device and the first cell is less than or equal to the first threshold; and
adding a first measurement report entry to a measurement report list variable.

4. The method according to claim 3, wherein the measurement report further comprises at least one of a measurement result of the serving cell or a measurement result of the first cell.

5. The method according to claim 2, wherein:
the first condition comprises the distance between the terminal device and the first cell being less than or equal to the first threshold; and
performing the handover from the serving cell to the first cell in the case where the terminal device and the first cell satisfy the first condition comprises:
performing a conditional handover (CHO) from the serving cell to the first cell in a case where the distance between the terminal device and the first cell is less than the first threshold; or
performing a CHO from the serving cell to the first cell in a case where the distance between the terminal device and the first cell is equal to the first threshold; or
performing a CHO from the serving cell to the first cell in a case where the distance between the terminal device and the first cell is less than or equal to the first threshold within a first time period.

6. The method according to claim 1, further comprising:
performing a first process in a case where the terminal device and the first cell satisfy a second condition;
wherein the first process comprises at least one of:
deleting a first measurement report entry from a measurement report list variable;
refraining from transmitting the first information to the network device;
refraining from performing the handover from the serving cell to the first cell;
transmitting second information to the network device, wherein the second information is used to indicate that the terminal device satisfies the second condition; or
transmitting second information to the network device, wherein the second information is used to indicate that the terminal device does not satisfy the first condition.

7. The method according to claim 6, wherein performing the first process in the case where the terminal device and the first cell satisfy the second condition comprises:
performing the first process in a case where the terminal device and the first cell satisfy the second condition within a second time period, wherein the second condition comprises at least one of:
a distance between the terminal device and the first cell being greater than a second threshold;
a distance between the terminal device and the first cell being equal to a second threshold;
the terminal device not entering a coverage of the first cell; or
the terminal device not entering a coverage of the first cell within a second time period.

8. The method according to claim 1, wherein the first condition belongs to a trigger event or a first conditional event.

9. The method according to claim 6, wherein the second condition belongs to a trigger event or a first conditional event.

10. The method according to claim 8, wherein:
configuration information of the trigger event comprises at least one of: a reference location; a first parameter value; or a third threshold; wherein a first threshold is the third threshold, or a first threshold is a difference between the third threshold and the first parameter value; and a second threshold is the third threshold, or a second threshold is a sum of the third threshold and the first parameter value; and
configuration information of the first conditional event comprises at least one of: a reference location; a first parameter value; or a third threshold; wherein a first threshold is the third threshold, or a first threshold is a difference between the third threshold and the first parameter value; and a second threshold is the third threshold, or a second threshold is a sum of the third threshold and the first parameter value.

11. The method according to claim 10, wherein a distance between the terminal device and the first cell is a distance between the terminal device and the reference location.

12. The method according to claim 8, wherein the trigger event is configured by the network device or defined by a communication protocol, and the first conditional event is configured by the network device or defined by a communication protocol.

13. The method according to claim 2, wherein the terminal device entering the coverage of the first cell is determined based on second information, wherein the second information comprises at least one of:
a measurement result of at least one candidate cell, wherein the measurement result of the at least one candidate cell is associated with the coverage of the first cell;
a measurement result of at least one beam, wherein the measurement result of the at least one beam is associated with the coverage of the first cell;
non-cellular wireless information; or
location information of the first cell;
wherein the non-cellular wireless information comprises at least one of: information carried by a wireless local area network (WLAN) signal; information indicated by a WLAN signal; information carried by a wireless fidelity (Wi-Fi) signal; information indicated by a Wi-Fi signal; information carried by a Bluetooth signal; information indicated by a Bluetooth signal; information carried by a radar signal; or information indicated by a radar signal; and
the second information is configured by the network device or defined by a communication protocol.

14. The method according to claim 13, wherein:
the first condition comprises the terminal device entering the coverage of the first cell, and the first information comprises first indication information; and
transmitting the first information to the network device in the case where the terminal device and the first cell satisfy the first condition comprises:
transmitting, in a case where the terminal device enters the coverage of the first cell, the first indication information to the network device, wherein the first indication information is used to indicate that the terminal device enters the coverage of the first cell.

15. The method according to claim 14, wherein transmitting the first indication information to the network device in the case where the terminal device enters the coverage of the first cell comprises:
transmitting the first indication information to the network device in a case where the terminal device is within the coverage of the first cell within a first time period.

16. The method according to claim 13, wherein:
the first condition comprises the terminal device entering the coverage of the first cell; and
performing the handover from the serving cell to the first cell in the case where the terminal device and the first cell satisfy the first condition comprises:
performing a conditional handover (CHO) from the serving cell to the first cell in a case where the terminal device enters the coverage of the first cell.

17. The method according to claim 16, wherein performing the CHO from the serving cell to the first cell in the case where the terminal device enters the coverage of the first cell comprises:
performing the CHO from the serving cell to the first cell in a case where the terminal device is within the coverage of the first cell within a first time period.

18. The method according to claim 1, wherein the first cell comprises a non-terrestrial network (NTN) cell or a terrestrial network (TN) cell.

19. A terminal device, comprising:
a processor;
a receiver and/or a transmitter connected to the processor; and
a memory, configured to store one or more executable instructions of the processor;
wherein the terminal device is configured to:
transmit first information to a network device and/or performing a handover from a serving cell to a first cell in a case where the terminal and the first cell satisfy a first condition.

20. A network device, comprising:
a processor;
a receiver and/or a transmitter connected to the processor; and
a memory, configured to store one or more executable instructions of the processor;
wherein the network device is configured to:
configure a first condition for a terminal device, wherein the first condition is used to evaluate the terminal device and a first cell.
